(19) United States
(12) Patent Application Publication
(10) Pub. No.: US 2008/0085020 A1
(43) Pub. Date: Apr. 10, 2008

(54) VIBRATION UNIT

(76) Inventors: Chi-Yi Tsai, Taichung (TW); Yu-Lun Lin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/539,063

(22) Filed: Oct. 5, 2006

(51) Int. Cl. H04R 25/00; H04R 17/02; H04R 19/04; H04R 21/02; H04R 11/04; H04R 9/08

(52) U.S. Cl. 381/178; 381/369

(57) ABSTRACT

A vibration unit includes a sound ring and a membrane attached to the sound ring. The membrane includes a rim for attachment to a shell of an acoustic device, a convex-concave annular region, a first non-planar connective region between the convex-concave annular region and the rim, a convex-concave circular region and a second non-planar connective region between the convex-concave circular region and the convex-concave annular region.

### BACKGROUND OF INVENTION

1. Field of Invention

The present invention relates to a vibration unit of a microphone or earphone and, more particularly, to a vibration unit with high fidelity.

2. Related Prior Art

Referring to FIGS. 8 through 10, there is shown a conventional vibration unit of a microphone or earphone. The vibration unit includes a membrane and a sound ring 7. The membrane includes a planar rim 1, a low-to-medium frequency region 2 and a high frequency region 3. The planar rim 1 is attached to a shell of the microphone or earphone. The low-to-medium frequency region 2 is located within and extended from the planar rim 1. The low-to-medium frequency region 2 is in the form of a dome. Ribs 4 are formed on the low-to-medium frequency region 2. Each of the ribs 4 includes a V-shaped form when it is viewed in a cross-sectional view such as FIGS. 9 and 10. A planar connective region 5 is formed between the low-to-medium frequency region 2 and the high frequency region 3. The planar connective region 5 is attached to the sound ring 7 by vibration-proof glue 6. As best shown in FIG. 10, the vibration-proof glue 6 is provided on an internal side of the sound ring 7.

Several problems have been encountered in using the conventional vibration unit. Firstly, the planar connective region 5 is made wider than the sound ring 7, as best shown in FIG. 10, for ensuring that they can be joined together; the planar connective region 5 so large however jeopardizes the fidelity of the vibration of the membrane. Secondly, the angle between the planar connective region 5 and the sound ring 7 is 90 degrees so that the connection by the vibration-proof glue 6 is weak and unstable. The weak and unstable connection entails bad quality and a short life of the vibration unit.

The present invention is therefore intended to obviate or at least alleviate the problems encountered in prior art.

### SUMMARY OF INVENTION

According to the present invention, a vibration unit includes a sound ring and a membrane attached to the sound ring. The membrane includes a rim for attachment to a shell of an acoustic device, a convex-concave annular region, a first non-planar connective region between the convex-concave annular region and the rim, a convex-concave circular region and a second non-planar connective region between the convex-concave circular region and the convex-concave annular region.

The primary advantage of the vibration unit according to the present invention is excellent strength and sensitivity of the membrane for using the bent or concave-convex annular region.

Other advantages and features of the present invention will become apparent from the following description referring to the drawings.

### BRIEF DESCRIPTION OF DRAWINGS

The present invention will be described through detailed illustration of three embodiments referring to the drawings.

FIG. 1 is a perspective view of a vibration unit of a microphone or ear phone according to the first embodiment of the present invention.

FIG. 2 is a cross-sectional view of the vibration unit shown in FIG. 1.

FIG. 3 is an enlarged partial cross-sectional view of the vibration unit shown in FIG. 2.

FIG. 4 is a cross-sectional view of a vibration unit according to the second embodiment of the present invention.

FIG. 5 is an enlarged partial cross-sectional view of the vibration unit shown in FIG. 4.

FIG. 6 is a cross-sectional view of a vibration unit according to the third embodiment of the present invention.

FIG. 7 is an enlarged partial cross-sectional view of the vibration unit shown in FIG. 6.

FIG. 8 is a perspective view of a conventional vibration unit of a microphone or ear phone.

FIG. 9 is a cross-sectional view of the conventional vibration unit shown in FIG. 8.

FIG. 10 is an enlarged partial cross-sectional view of the vibration unit shown in FIG. 9.

### DETAILED DESCRIPTION OF EMBODIMENTS

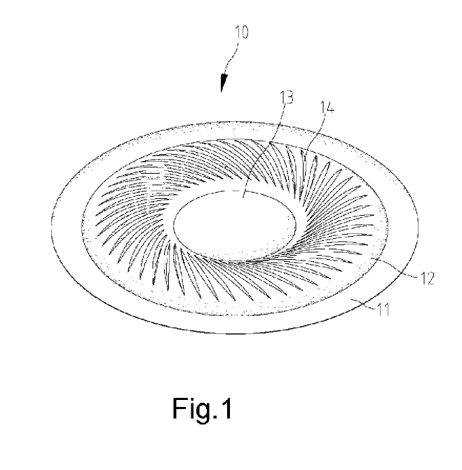

Referring to FIGS. 1 through 3, there is shown a vibration unit for use in an acoustic device such as a microphone or earphone according to a first embodiment of the present invention. The vibration unit includes a membrane 10 and a sound ring 20 for supporting the membrane 10.

The membrane 10 includes a planar rim 11, a convex-concave annular region 12 and a convex-concave circular region 13. The planar rim 11 is attached to an annular edge of a shell of the microphone or earphone.

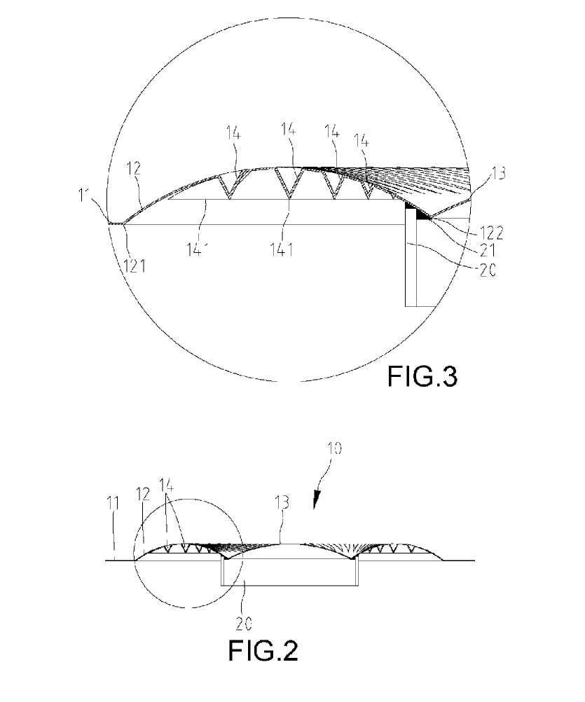

The convex-concave annular region 12 is located within and extended from the planar rim 11. A bent connective region 121 is formed between the convex-concave annular region 12 and the planar rim 11. The convex-concave annular region 12 includes a convex upper face and a concave lower face. Ribs 14 are formed on the convex-concave annular region 12. Each of the ribs 14 includes a V-shaped form in a cross-sectional view such as FIGS. 2 and 3. The angle between each of the ribs 14 and a radius is large so that many ribs 14 are seen in a cross-sectional view taken along a radius such as FIGS. 2 and 3. In other words, many ribs 14 intersect any given radius. Thus, the strength of the convex-concave annular region 12 is enhanced by the ribs 14.

The convex-concave circular region 13 is located within and extended from the convex-concave annular region 12. A bent connective region 122 is formed between the convex-concave circular region 13 and the convex-concave annular region 12. The bent connective region 122 provides an adequate strength. The convex-concave circular region 13 includes a convex upper face and a concave lower face.

The bent connective region 121 may be located lower or higher than the bent connective region 122 or they may be located in a same plane. The bent connective region 121 is preferably located lower than the bent connective region 122 for excellent sensitivity of the membrane 10.

The convex-concave annular region 12 is attached to the sound ring 20 by vibration-proof glue 21. The vibration-proof glue 21 is provided on an internal side and the top of the sound ring 20 so that the connection of the convex-concave annular region 12 to the sound ring 20 is firm.

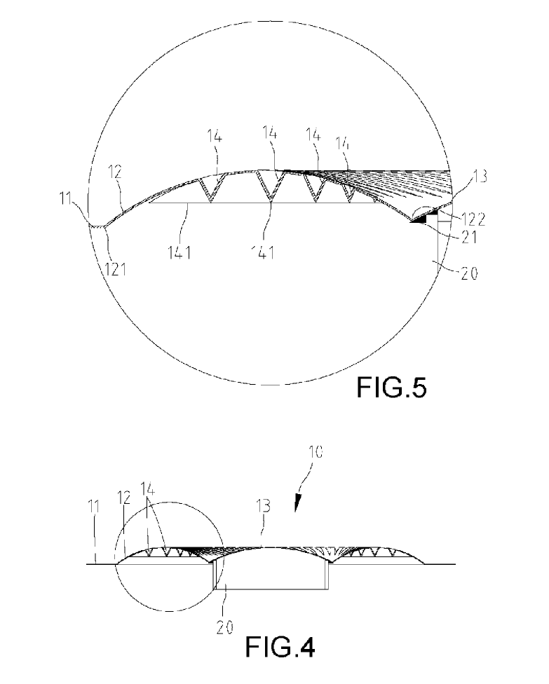

Referring to FIGS. 4 and 5, there is shown a vibration unit according to a second embodiment of the present invention. The second embodiment is identical to the first embodiment except the sound ring 20 is connected to the convex-concave circular region 13 instead of the convex-concave annular region 12. Accordingly, the vibration-proof glue 21 is provided on the top and an external side of the sound ring 20,

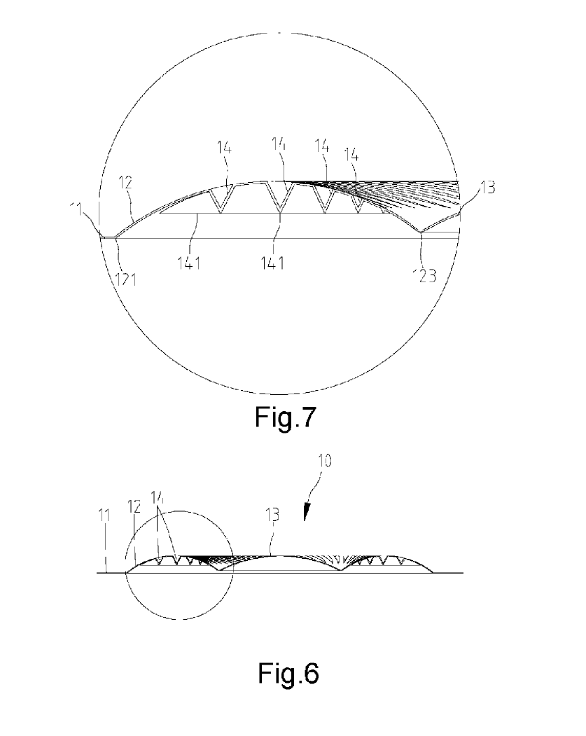

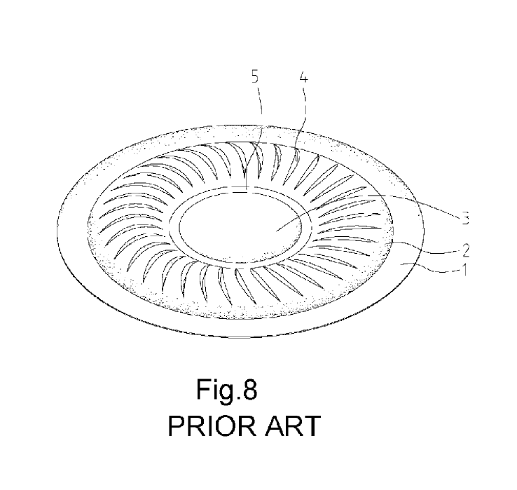

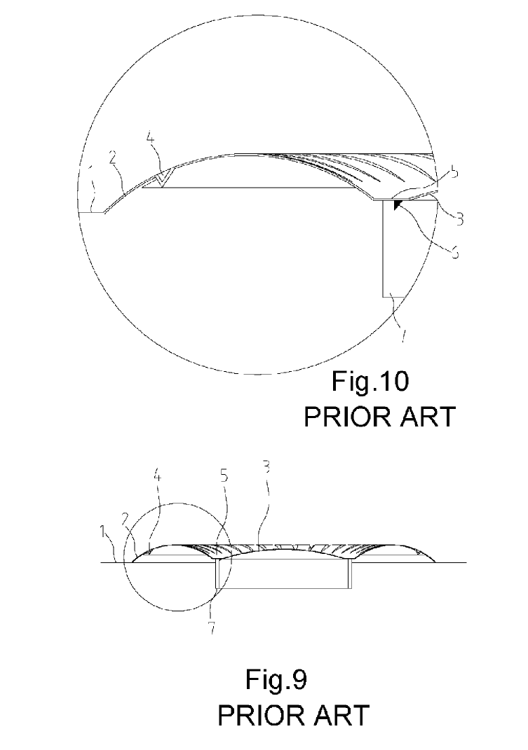

Referring to FIGS. 6 and 7, there is shown a vibration unit according to a third embodiment of the present invention. The third embodiment is identical to the first embodiment except including a concave-convex connective region 123 instead of the bent connective region 122.

The vibration unit according to the present invention exhibits several advantages. Firstly, the membrane is stronger and more sensitive than the conventional membrane addressed in the Related Prior Art for using the bent or concave-convex annular region instead of the flat connective region of the conventional membrane.

Secondly, the connection of the membrane to the sound ring is firm since the vibration-proof glue is provided on the top and the internal or external side of the sound ring.

Thirdly, the membrane is very sensitive when the bent connective region 122 is located higher than the bent connective region 121.

The present invention has been described via the detailed illustration of the embodiments. Those skilled in the art can derive variations from the embodiments without departing from the scope of the present invention. Therefore, the embodiments shall not limit the scope of the present invention defined in the claims.

What is claimed is:

1. A vibration unit comprising a sound ring and a membrane attached to the sound ring and formed with a rim for attachment to a shell of an acoustic device, a convex-concave annular region, a first non-planar connective region between the convex-concave annular region and the rim, a convex-concave circular region and a second non-planar connective region between the convex-concave circular region and the convex-concave annular region so that the membrane exhibits excellent rigidity and sensitivity.

2. The vibration unit according to claim 1 wherein the second non-planar connective region is a bent connective region.

3. The vibration unit according to claim 1 wherein the second non-planar connective region is a concave-convex connective region.

4. The vibration unit according to claim 1 wherein the convex-concave annular region is attached to the sound ring.

5. The vibration unit according to claim 4 comprising vibration-proof glue for attaching the convex-concave annular region to the sound ring.

6. The vibration unit according to claim 5 wherein the vibration-proof glue is provided on the top and an internal side of the sound ring.

7. The vibration unit according to claim 1 wherein the convex-concave circular region is attached to the sound ring.

8. The vibration unit according to claim 7 comprising vibration-proof glue for attaching the convex-concave circular region to the sound ring.

9. The vibration unit according to claim 8 wherein the vibration-proof glue is provided on the top and an external side of the sound ring.

10. The vibration unit according to claim 1 wherein the first non-planar connective region is located lower than the second non-planar connective region.

11. The vibration unit according to claim 1 wherein the first and second non-planar connective regions are located in a same plane.

12. The vibration unit according to claim 1 wherein the first non-planar connective region is located higher than the second non-planar connective region.
